(19) United States
(12) Patent Application Publication
(10) Pub. No.: US 2004/0025706 A1
(43) Pub. Date: Feb. 12, 2004

(54) Microwave oven food-stirrer

(76) Inventor: David Mark Greenstreet, Great Missenden (GB)

Correspondence Address: David Mark Greenstreet, Little Orhard Kiln Road Prestwood, Great Missenden Buckinghamshire, HP16 9DG, GB

(21) Appl. No.: 10/416,881

(22) PCT Filed: Dec. 13, 2001
(86) PCT No.: PCT/GB01/05553

(30) Foreign Application Priority Data
Dec. 21, 2000 (GB) GB0031231.4

(51) Int. Cl. A23L 1/00

(52) U.S. Cl. 99/348

(57) ABSTRACT

A devise which makes use of the relative motion of a rotary plate inside a microwave oven for stirring food stuffs in a microwave oven so that an even heat distribution throughout the food is facilitated. The device consists of a Roof-Rail, a Roof-Fitting, and Stirring Implements and where necessary may employ a food receptacle securing method. The device is shown at FIG. 7 of the attached drawings.

### DESCRIPTION

1. This invention relates to a food-stirring device for use with microwave ovens (hereafter referred to as a Microwave Oven Food-Stirrer).

### BACKGROUND

2. It has been known for some time that the distribution of energy within a microwave oven is not uniform. There have been several developments in microwave technology to try to overcome the inconvenience this causes with microwave cooking (a rotary plate being one of them). However, it is still a fact today that when heating or cooking a dish that requires an even distribution of heat, the cooking period must be interrupted regularly in order to disperse the energy by manual means (ie dishes need a good stir every now and then!).

3. The idea of a Microwave Oven Food-Stirrer was born from the fact that while cooking or re-heating any of several food types in a microwave oven, there is a need to return to the oven periodically to stir the food in order to ensure that it is cooked/re-heated evenly. A microwave oven capable of stirring the food itself would give a far more even distribution of energy throughout the food during the cooking/re-heating period, reduce the cooking time required and allow the cooking period to be continuous (a procedure recommended for best results in most dishes). Other benefits of the incorporation of such a device may include the energy saving realized by the uninterrupted microwave function, the saving on the ware of microwave components realized by the same and the reduced tendency to destroy health-giving nutrients within food stuffs through over cooking.

4. A Microwave Oven Food-Stirrer is one method to facilitate this function. While this invention would be easy to incorporate into the design of a new oven, to be included during manufacture, it is designed primarily as an accessory (a separate stand-alone enhancement) to any existing microwave oven which incorporates a rotary plate.

### PURPOSES

5. Primary. The primary purpose of this invention is to enhance the distribution of heat through food which being cooked or heated in a microwave oven.

6. Secondary. A secondary purpose is to provide a stirring or whisking capability during the process of microwave cooking.

### METHOD

7. The method by which the purposes of this invention are met is through use of the internal rotary plate (Item 6) of a microwave oven to provide rotation of the food/beverage, while a stationary stirring implement placed into the food/beverage creates a relative stirring/mixing action through it.

### DETAILS

8. Specific details of the invention are as follows:

a. All constituent parts of the invention would need to be manufactured in a microwave-proof material.

b. The main constituent parts of the invention are:

(1) Roof-Rail.

(2) Roof-Fittings.

(3) Stirring Implement.

(4) Adhesive.

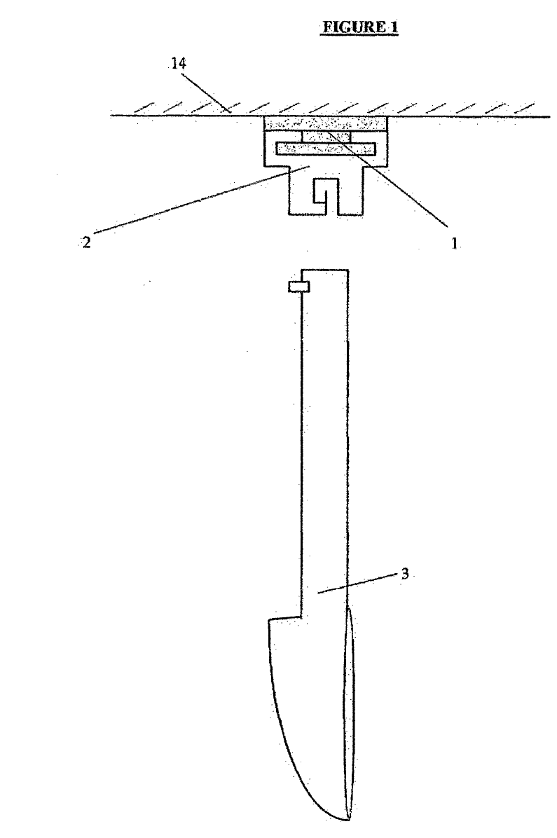

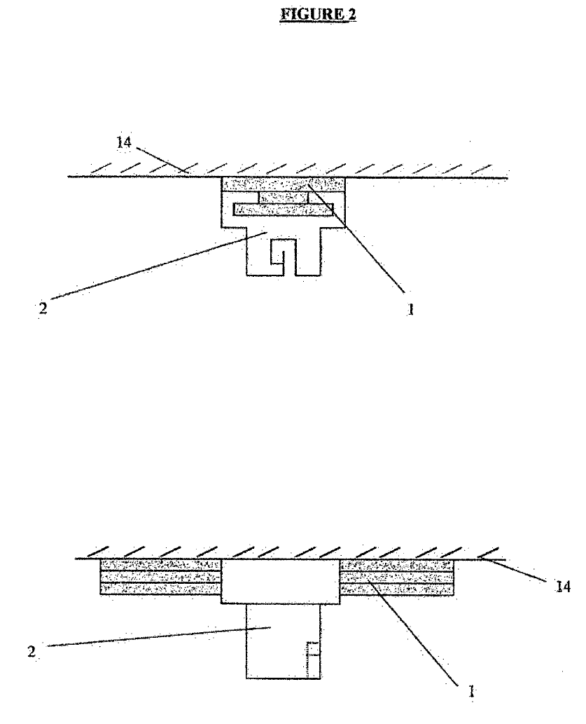

9. Roof-Rail (FIG. 1, Item 1). The Roof-Rail is an “l” sectioned strip which is secured to the roof (Item 14) of the microwave oven on a radial from its centre using adhesive. Ideally Roof Rails would be positioned on the roof along the radial running perpendicular to the back wall of the oven, from the back wall to just beyond the centre. Along the Roof-Rail would slide a Roof-Fitting (FIG. 1, Item 2). While the Roof-Rail could be fitted retrospectively to any microwave oven using suitable adhesive, ideally, it would be incorporated into the microwave oven design during manufacture. (The Roof-Rail and Roof-fitting are shown in clear detail at FIG. 2).

10. Roof-Fitting (FIG. 1, Item 2). Roof-fittings are designed to ride snugly along the Roof-Rail (Item 1) and incorporate a female ‘bayonet’ type fitting to receive Stirring Implements (Item 3). The bayonet fitting would be position to be facing the front of the oven for case of insertion of Stirring Implements. Roof fittings would vary in length to cater for different sized ovens and to vary the depth of a Stirring Implement within the food/receptacle (Item 4). The varied position of a Roof-Fitting along the Roof-Rail would allow the Microwave Oven Food-Stirrer to be located in a position to provide an optimum stirring capability within different sized receptacles. (The Roof-Rail and Roof-Fitting are shown in clear detail at FIG. 2).

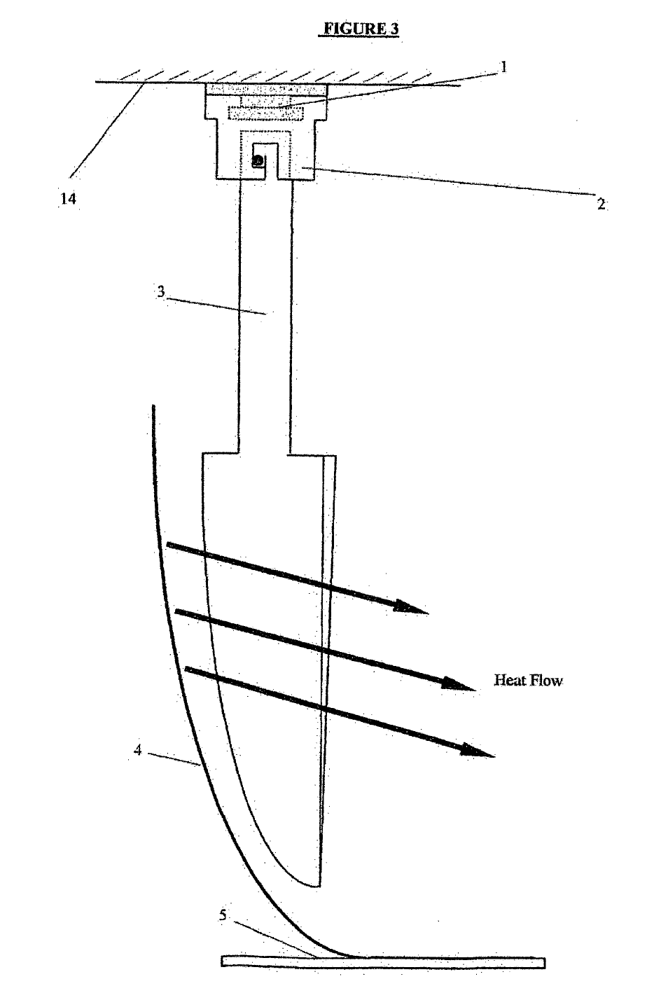

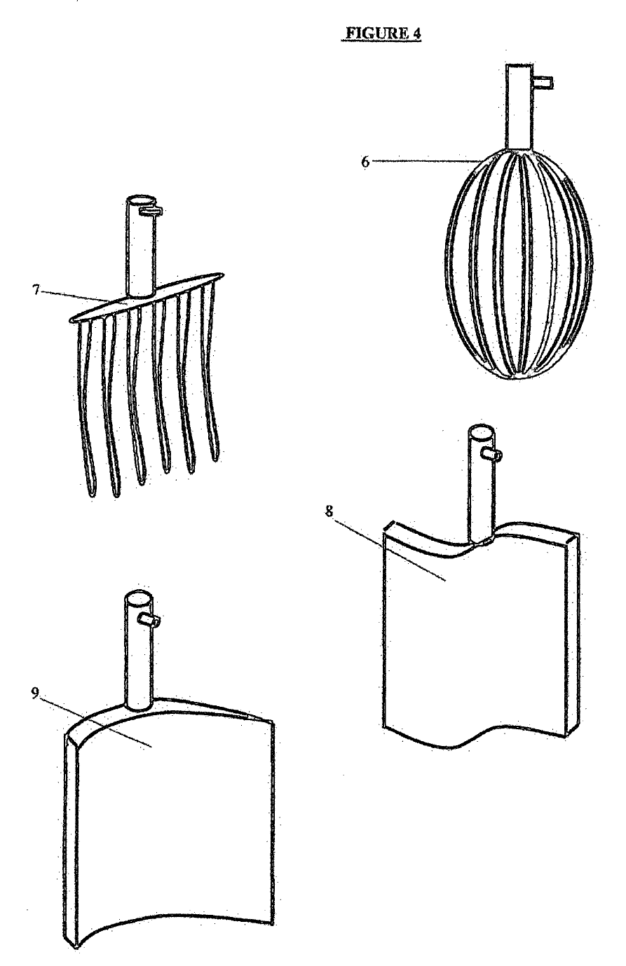

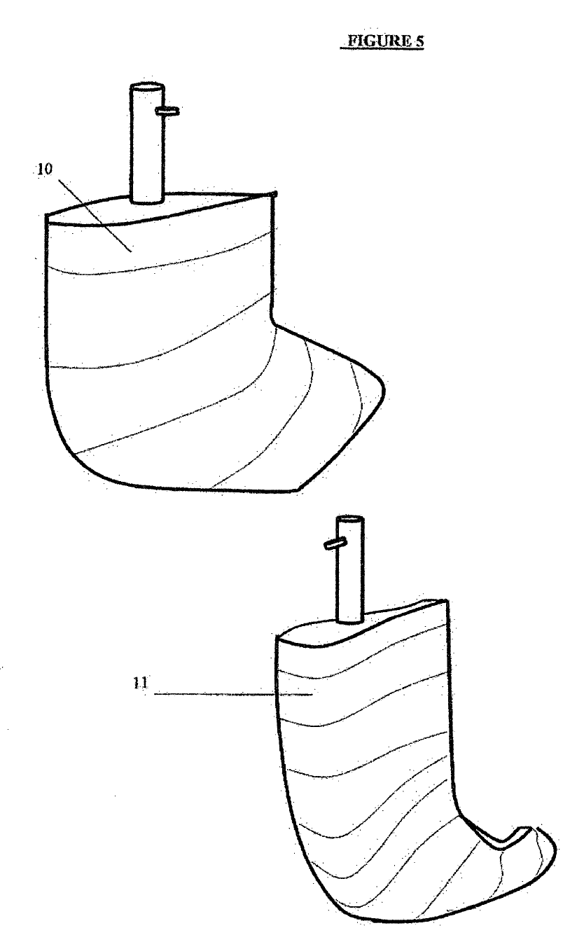

12. Stirring Implement (FIG. 1, Item 3 (FIGS. 4 & 5 Items 6, 7, 8, 9, 10 & 11). Stirring Implements have a male ‘bayonet’ type fitting incorporated into their design for attachment to Roof Fittings. Male bayonet fittings would be positioned so that on connection to the female, the Stirring Implement is angled within the food/receptacle for optimum stirring capability. Stirring Implements are designed for different mixing/stirring functions and different sized receptacles/bowls. Generally, they are contoured to the walls of different receptacle types in order to provide optimum stirring capability and bring the hotter food toward the centre—see FIG. 3. Of the numerous Stirring Implement design options, some are a ‘Whisk-type’ (FIG. 4, Item 6). ‘Fork-type’ (FIG. 4, Item 7), ‘Wave-type’ (FIG. 4, Item 8), and ‘Concave-type’ implements (FIG. 4, Item 9). More complex ‘aerodynamic’ type designs, such as those shown in FIG. 5, Items 10 and 11, are other options for achieving a more even distribution of heat through the food/beverage.

13. Optional Constituent Parts/Design Features. To further enhance the effectiveness of the Microwave Oven Food-Stirrer, a number of optional constituent parts/design features may be considered as additions to its fundamental design. These are:

a. Rotary Plate Non-Slip Mat (not shown). To ensure that the food receptacle maintains its rotation with the rotary plate while using the Microwave Oven Food Stirrer, a Non-Slip Mat may be placed between the food receptacle and rotary plate.

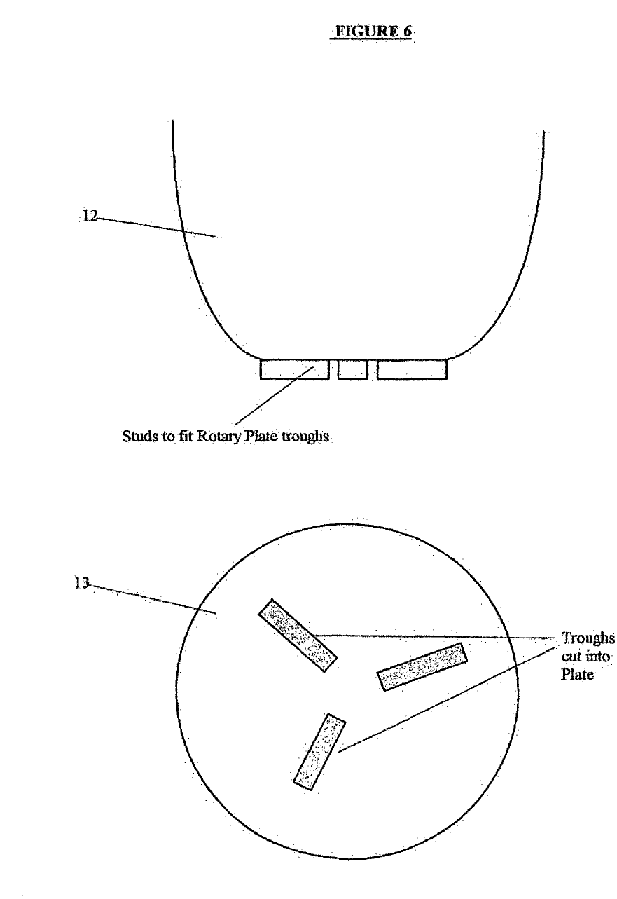

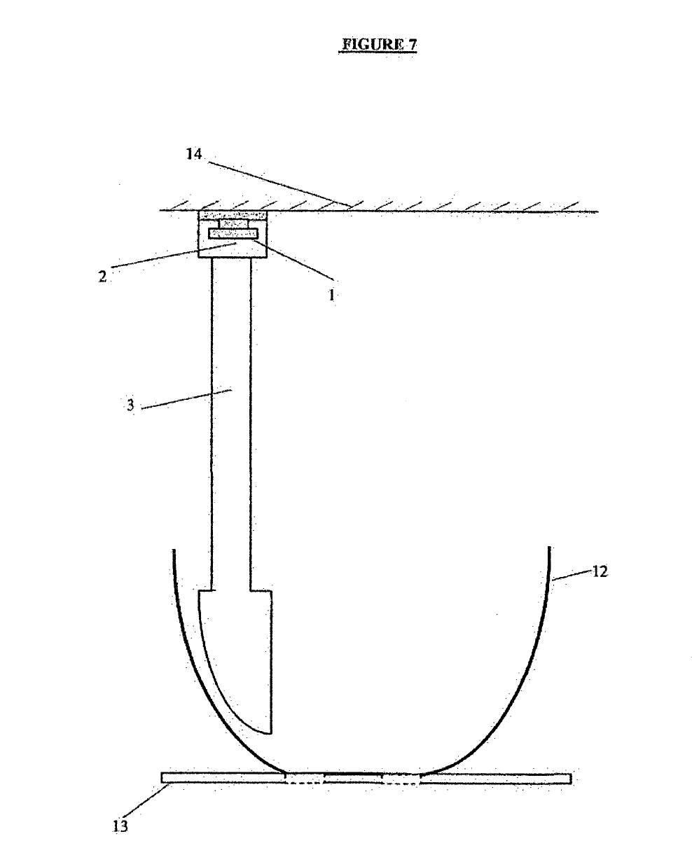

b. Secure Bowl and Rotary Plate (FIG. 6, Items 12 and 13). To further ensure that the food receptacle maintains its rotation with the rotary plate while using the Microwave oven Food Stirrer, a rotary plate and bowl with interlocking troughs and studs (tines) as shown at FIG. 7 may be used.

c. Variable-Speed Rotary Plate. Designing the rotary plate so that it could rotate at various speed would permit varying speeds of stirring action. Different speeds may be optimised for different food/beverage types. (For a fast rotation, it would be necessary to incorporate a receptacle securing method such as either of those described in paragraphs 13a and 13b above).

d. Secondary Rotation. To enhance the stirring/whisking effect, the Microwave Oven Food Stirrer, as an integral part of a microwave oven, could be designed to rotate through its ‘point of contact’ with the oven roof. (In this case, the Roof-Rail would not feature as part of the item).

14. The complete assembly is shown at FIG. 7.

1. A device for stirring food in a Microwave Oven comprising Roof-Rails, Roof-Fittings, Stirring Implements, adhesive and as an additional consideration, a non-slip mat or secure bowl to rotary plate assembly.

2. A device for stirring food in a microwave oven as claimed in claim 1 for which the method of stirring is provided by the relative motion of the device in relation to the food/beverage which is rotated in a receptacle by use of an oven's internal rotary plate.

3. A device for stirring food in a microwave oven as claimed in claim 1 and 2 for which the effectiveness may be increased by varying the speed of the rotary plate of a microwave oven so as to vary the speed of the relative motion of the device through the food/beverage in which it is placed.

4. A device for stirring food in a microwave oven as claimed in claim 1, 2 and 3 for which the purposes are to enhance the distribution of heat through food which is being cooked or heated and/or to provide a stirring or whisking capability during the process of microwave cooking.

5. A device for stirring food in a microwave oven as described herein with reference to FIGS. 1-7 of the accompanying drawing.
